(19) United States
(12) Patent Application Publication
(10) Pub. No.: US 2004/0017339 A1
(43) Pub. Date: Jan. 29, 2004

(54) Liquid crystal display and driving method thereof

(75) Inventor: Jong-Min Wang, Seongnam-City (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/438,009

(22) Filed: May 15, 2003

(30) Foreign Application Priority Data
Jul. 26, 2002 (KR) 2002-44249

(51) Int. Cl. G09G 3/36

(52) U.S. Cl. 345/87

(57) ABSTRACT

A liquid-crystal display including a liquid-display panel having a first electrode and a second electrode, with a liquid crystal therebetween, and a driver for supplying a first electric potential to the first and the second electrodes with a duty that is set to have a ratio of a display-on period to a set AC driving period exceeding 50%, and, during a display-off period of the set AC driving period, the driver supplies a second electric potential to the first and the second electrode, the second electric potential having an opposite polarity to the first electric potential and a greater level than that of the first electric potential. Consequently, the liquid-crystal display and the driving method thereof can prevent the transmittance loss and thus increase brightness.

### BACKGROUND OF THE INVENTION

1. Field of the Invention

The present invention relates to a liquid-crystal display and a driving method thereof, and more particularly to a liquid-crystal display and a driving method thereof capable of increasing transmittance to thus raise brightness.

The present application is based on Korean Patent Application No. 2002-44249, filed Jul. 26, 2002, which is incorporated herein by reference in its entirety.

2. Description of the Prior Art

As a flat screen-type display, a liquid-crystal display has been mainly used in mobile apparatuses. With the development of large-sized apparatuses-oriented technology, the related industry was quick to employ the liquid-crystal display instead of a conventional CRT (Cathode Ray Tube) display.

The liquid-crystal display displays information by supplying a predetermined voltage during a display period allocated within an alternating current (AC) driving period. Such a liquid-crystal display prevents an afterimage from occurring by using a direct current (DC) balance driving method. The DC balance driving method supplies a reverse voltage having the same level as that of the voltage supplied during the display period so as to relax an electric charge accumulated in an alignment layer during the display period to an initial level.

FIG. 1 is a graph showing a relation between a supply voltage and a transmittance consistent with a conventional DC balance driving method performed with a duty ratio of 50%.

Ta denotes the AC driving period, and the letters in each bracket denote colors corresponding to the respective AC driving periods in one frame.

As shown in the graph of FIG. 1, a voltage of 3V is supplied during a display period Ta1 that corresponds to a half of the AC driving period Ta, while a voltage of −3V is supplied during the remaining display period Ta2.

In this DC balance driving method, the time to supply the reverse voltage is determined to be longer than the time that is required to sufficiently relax the electric potential accumulated during the display period Ta1.

However, consistent with the conventional driving method of the liquid-crystal display as described above, radiant energy is blocked during the reverse electric potential supplying period Ta2 of the AC driving period Ta.

Consequently, if a minimum value of the voltage that generates a maximum tilt of the liquid-crystal during the AC driving period Ta is 3, the transmittance attained is 50% on average.

That is, the conventional DC balance driving method can protect the liquid-crystal from being damaged, but has a disadvantage in that it cannot attain a transmittance of more than 50% on average with respect to the incident radiant energy during the AC driving period Ta.

In order to prevent the radiant energy loss, the duty ratio of the display period Ta1 can be extended to 70% as shown in FIG. 2. However, the time to supply the reverse voltage (i.e. Ta2) becomes shortened, and consequently, the electric charge accumulated on the alignment layer during the display period Tat cannot be sufficiently relaxed, causing an afterimage problem.

That is, as shown in FIG. 3, an electric charge is accumulated in alignment layers 2 and 6 adjacent to a liquid-crystal layer 4 due to an electric field E that is generated corresponding to the electric potential supplied during the display period Ta1. If the reverse voltage supplying period Ta2 is set shorter than the time required to relax the accumulated electric charge, some of the accumulated electric charge remains to thereby generate a remainder DC voltage that causes an afterimage. The reference numeral 4 indicates the liquid-crystal layer. The reference character E′ denotes the electric field that is generated due to the electric charge accumulated during the display period Ta1, and the reference character ELC denotes a difference between an electric field E generated by the supply voltage and the electric field E′ generated by the accumulated electric charge.

As described above, the conventional driving method of the liquid-crystal display has a problem in that, to remove the electric charge accumulation during the AC driving period, it cannot attain more than 50% in the transmittance.

### SUMMARY OF THE INVENTION

The present invention has been developed in order to solve the above problem in the prior art. An aspect of the present invention is to provide a liquid-crystal display and a driving method thereof capable of preventing a transmittance loss and an afterimage from occurring.

The above aspect is achieved by providing a liquid-crystal display comprising a liquid-display panel having a first electrode and a second electrode, with a liquid crystal therebetween. The liquid crystal display further comprising a driver for supplying a predetermined electric potential to the first and second electrodes to display information on the liquid-display panel. The driver supplies a first electric potential to the first and the second electrodes with a duty that is set to have a ratio of a display-on period to a set AC driving period exceeding 50%, and, during a display-off period of the set AC driving period, the driver supplies a second electric potential to the first and the second electrodes, the second electric potential having an opposite polarity to the first electric potential and a higher level than that of the first electric potential.

Also, the above aspect is achieved by providing a driving method of a liquid-crystal display comprising a display panel having a first electrode and a second electrode with a liquid crystal therebetween, the first electrode and the second electrode being arranged in an orthogonal direction to each other, and a driver controlling an electric potential supply to the first and the second electrodes. The driving method comprises a displaying step supplying a first electric potential to the first and the second electrodes with a duty that is set to have a ratio of a display-on period to a set AC driving period exceeding 50%, and a reset step supplying a second electric potential to the first and the second electrodes during a display-off period of the set AC driving period, the second electric potential having a greater absolute value than that of the first electric potential and a reverse polarity to the first electric potential.

### BRIEF DESCRIPTION OF THE DRAWINGS

The above aspect and a feature of the present invention will more apparent by describing an illustrative embodiment of the preset invention with reference to the accompanying drawings, in which:

FIG. 1 is a graph showing a relation between a supply voltage and a transmittance consistent with a conventional DC balance driving method having a duty ratio of 50%;

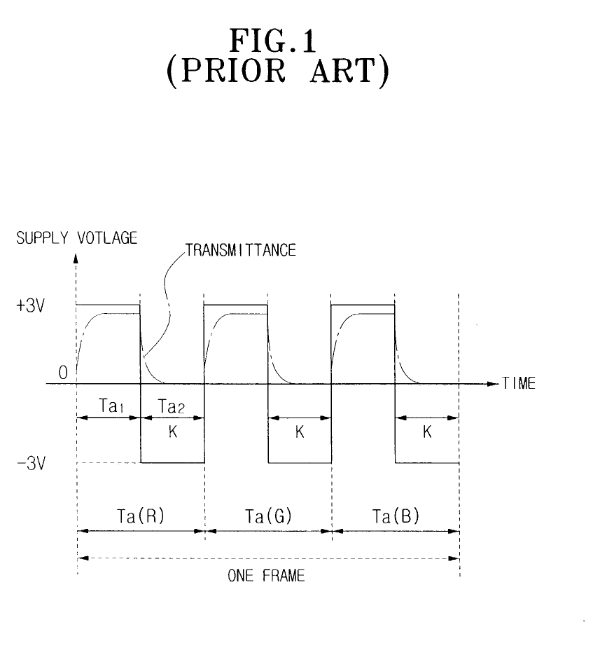

FIG. 2 is a graph showing a relation between the supply voltage and the transmittance with the duty ratio exceeding 50%;

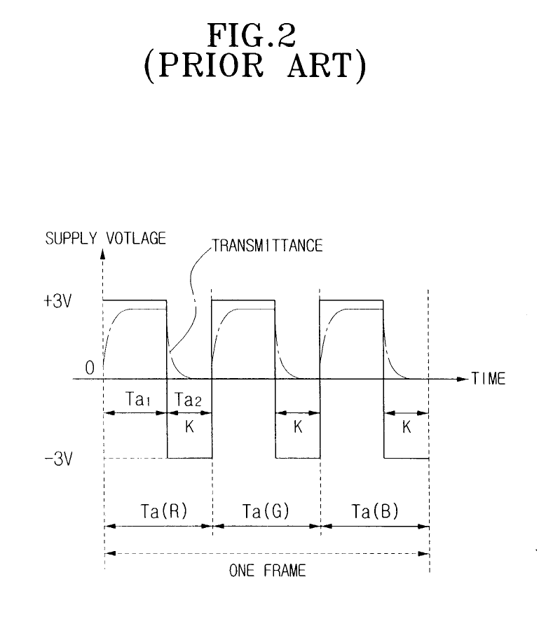

FIG. 3 is a view showing an electric charge that is accumulated by the driving method of FIG. 2, causing an afterimage problem;

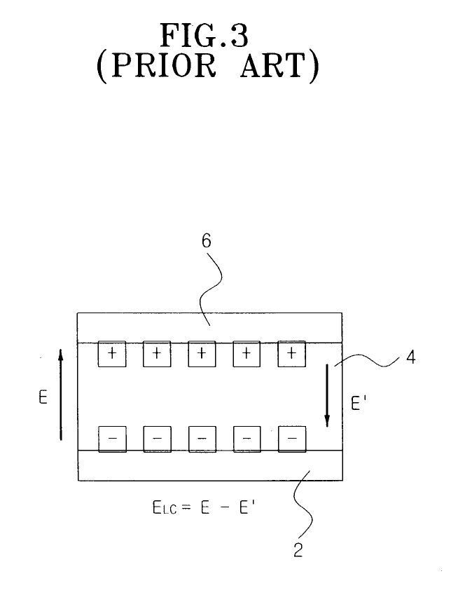

FIG. 4 is a view showing a liquid-crystal display consistent with the present invention;

FIG. 5 is a graph showing a waveform of a driving voltage supplied by the driver of FIG. 4; and

FIG. 6 is a graph showing a relation between a supply voltage and a transmittance when the liquid-crystal display panel is driven by a driving method of the present invention.

### DESCRIPTION OF THE PREFERRED EMBODIMENT

Hereinbelow, the present invention will be described in greater detail with reference to the accompanying drawings.

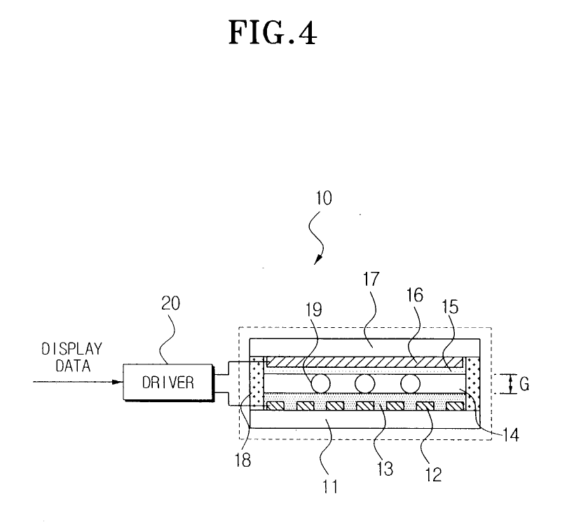

FIG. 4 is a cross-sectional view showing a ferroelectric liquid-crystal display consistent with the present invention.

Referring to FIG. 4, the liquid-crystal display comprises a liquid-crystal display panel 10 and a driver 20.

The liquid-crystal display panel 10 comprises a lower substrate 11, a lower electrode layer 12, a lower alignment layer 13, a liquid-crystal layer 14, an upper alignment layer 15, an upper electrode layer 16, an upper substrate 17, a sealing member 18, and a spacer 19.

Exemplary for the lower and the upper substrates 11 and 17 are transparent materials such, as glass or transparent synthetic resins.

The lower and upper electrode layers 12 and 16 comprise known transparent material, for example, an ITO (Indium Tin Oxide) material.

Preferably, a plurality of electrodes are arranged on the lower and the upper electrode layers 12 and 16, wherein the electrodes of the lower electrode layer 12 have an orthogonal relation to those of the upper electrode layer 16.

The liquid-crystal layer is filled with liquid-crystal material.

The lower and the upper alignment layers 13 and 15 may be made from various generally known alignment layer materials such as polyimide, a poly vinyl alcohol, nylon, polyvinyl acetate, and the like.

The lower and the upper alignment layers 13 and 15 are rubbed by rubbing material, such as cloth, with a predetermined angle.

The spacer 19 is for maintaining a constant gap G of the liquid-crystal layer 14.

Since the gap G of the liquid-crystal layer 14 is related to a relaxing response time τ of the liquid crystal, the gap G is properly determined consistent with a driving condition.

The driver 20 supplies an electric potential having a predetermined frequency to the lower and the upper electrode layers 12 and 16 of a pixel consistent with display data. The driver 20 drives the lower and the upper electrode layers 12 and 16 of the liquid-crystal display panel 10 to display the display data.

The driver 20 is electrically connected to the lower and the upper electrode layers 12 and 16 to supply an AC electric potential set in relation to the display data through the lower and the upper electrode layers 12 and 16.

The driver 20 supplies a first electric potential to the lower and the upper electrode layers 12 and 16 with a duty ratio of a display-on period to a set AC driving period exceeding 50%. During a display-off period of the AC driving period, the driver 20 supplies a second electric potential, which has an opposite polarity to the first electric potential but has a higher level than that of the first electric potential, to the lower and the upper electrode layers 12 and 16. The display-off period corresponds to a reset process for removing an electric charge accumulation.

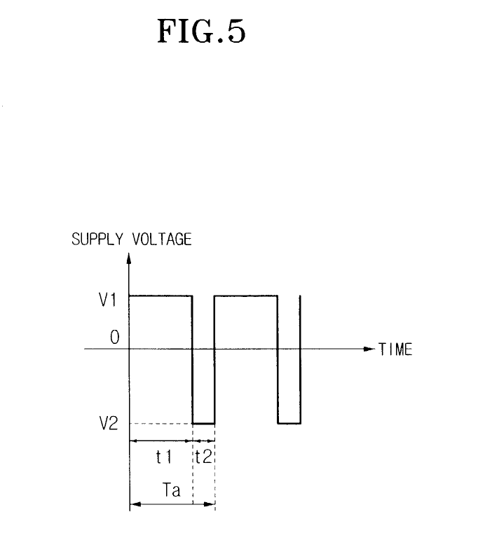

That is, as shown in FIG. 5, the display-on period t1 during which the driver 20 supplies the first electric potential V1 is longer than the display-off period t2 during which the driver 20 supplies the second electric potential V2.

However, the second electric potential V2 supplied during the display-off period t2 has an absolute value greater than that of the first electric potential V1 and has an opposite polarity to the first electric potential V1.

Preferably, parameters are determined so that a first multiplication value (t1×V1) obtained by multiplying the display-on period t1 by the first electric potential V1 has the same absolute value as that of a second multiplication value (t2×V2) obtained by multiplying the display-off interval t2 by the second electric potential V2.

Hereinafter, the descriptions given will be regarding the actions of ions of the liquid-crystal layer consistent with the driving method of the liquid-crystal display of the present invention.

Parameters in relation to a reaction time τ of the ions existing in the liquid-crystal layer are expressed by equation 1 as follows:

$$τ = \frac{G}{μ E} \qquad [ Equation 1 ]$$

where, G denotes a cell gap, μ denotes a mobility, and E denotes a level of an electric field.

Rearranging equation 1 with a function of the supply voltage V will render equation 2 as follows:

$$τ = \frac{α}{V} \qquad [ Equation 2 ]$$

where, α denotes a proportional constant.

The proportional constant of equation 2 can be expressed by equation 3 as follows:

α=t1×V1 [Equation 3]

In addition, from the relation of equation 2, the display-off period t2 during which the ions sufficiently react to be relaxed can be obtained by equation 4 as follows:

$${t}_{2} = \frac{α}{{V}_{2}} \qquad [ Equation 4 ]$$

Finally, equation 5 is obtained by substituting equation 3 for equation 4 as follows:

t₁×V₁=t₂×V₂ [Equation 5]

In conformity with equation 5, the relevant parameters are determined so that the value obtained by multiplying the display-on period t1 by the first voltage V1 equals the value obtained by multiplying the display-off period t2 by the second voltage V2. As a result, the duty ratio can be maintained at 50% or greater and the problem of the electric charge accumulation can be solved.

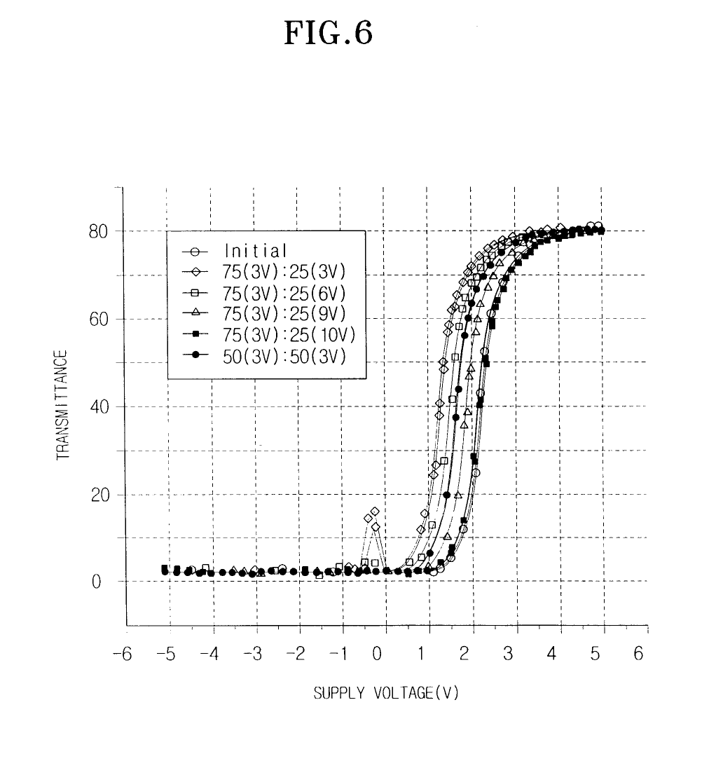

FIG. 6 shows a result of a test that was performed to observe the reactions of the liquid-crystal consistent with the DC balance driving principle.

In this test, the AC driving period was 1/180 second.

The curved line expressed with emptied circles indicates the relation between the transmittance and the supply voltage V in an initial alignment condition of the liquid-crystal.

The curved line expressed with emptied diamonds shows a result that was measured by performing the AC driving for an hour under the condition that the ratio of the display-on period t1 to the display-off period t2 is 75:25 and the first electric potential V1 and the second electric potential V2 are respectively 3V and −3V as shown in FIG. 5. As shown in the graph of FIG. 6, the curved line expressed with the emptied diamonds is moved to the left from the initial alignment condition and the remainder DC voltage is 1V or greater.

The curved line expressed with emptied squares shows a result that was measured by performing the AC driving for an hour under the condition that the ratio of the display-on period t1 to the display-off period t2 is 75:25 and the first electric potential V1 and the second electric potential V2 are respectively 3V and −6V. This curved line shows that the remainder DC voltage is reduced from that of the curved line expressed by the emptied diamonds.

The curved line expressed with emptied triangles shows a result that was measured by performing the AC driving for an hour under the condition that the ratio of the display-on period t1 to the display-off period t2 is 75:25 and the first electric potential V1 and the second electric potential V2 are respectively 3V and −9V. This driving condition is consistent with the condition satisfying equation 5 and is almost identical to the initial alignment condition. In this case, it is understood that a minor error occurs due to the inconsistent surface condition of the lower and the upper alignment layers 13 and 15.

The curved line expressed with filled squares shows a result that was measured by performing the AC driving for an hour under the condition that the ratio of the display-on period t1 to the display-off period t2 is 75:25 and the first electric potential V1 and the second electric potential V2 are respectively 3V and −10V. It is shown that this curved line is completely identical to that of the initial orientation condition.

The curved line expressed with filled circles shows a result that was measured by performing the conventional DC balance driving for an hour under the condition that the ratio of the display-on period t1 to the display-off period t2 is 50:50 and the first electric potential V1 and the second electric potential V2 are respectively 3V and −3V. In this case, there also occurs a minor error with respect to the curved line of the initial alignment condition, and it is also caused by the inconsistent surface condition of the lower and the upper alignment layers 13 and 15.

As described above, the liquid-crystal display and the driving method thereof consistent with the present invention can prevent the transmittance loss and thus increase brightness.

What is claimed is:

1. A liquid-crystal display comprising:
a liquid-display panel having a first electrode and a second electrode, with a liquid crystal therebetween; and
a driver for supplying a predetermined electric potential to the first and second electrodes to display information on the liquid-display panel,
wherein the driver supplies a first electric potential to the first and the second electrodes with a duty that is set to have a ratio of a display-on period to a set AC driving period exceeding 50%, and, during a display-off period of the set AC driving period, the driver supplies a second electric potential to the first and the second electrodes, the second electric potential having an opposite polarity to the first electric potential and a higher level than that of the first electric potential.

2. The liquid-crystal display of claim 1, wherein a first multiplication value obtained by multiplying the first electric potential by the display-on period has the same absolute value as that of a second multiplication value obtained by multiplying the second electric potential by the display-off period.

3. A driving method of a liquid-crystal display comprising a display panel having a first electrode and a second electrode with a liquid crystal therebetween, the first electrode and the second electrode being arranged in an orthogonal direction to each other, and a driver controlling an electric potential supply to the first and the second electrodes, the driving method comprising:
a displaying step supplying a first electric potential to the first and the second electrodes with a duty that is set to have a ratio of a display-on period to a set AC driving period exceeding 50%; and
a reset step supplying a second electric potential to the first and the second electrodes during a display-off period of the set AC driving period, the second electric potential having a greater absolute value than that of the first electric potential and a reverse polarity to the first electric potential.

4. The driving method of the liquid-crystal display of claim 3, wherein a first multiplication value obtained by multiplying the first electric potential by the display-on period has an absolute value that is the same as that of a second multiplication value obtained by multiplying the second electric potential by the display-off period.
